(19) United States
(12) Patent Application Publication
(10) Pub. No.: US 2013/0132843 A1
(43) Pub. Date: May 23, 2013

(54) METHODS OF EDITING PERSONAL VIDEOGRAPGHIC MEDIA

(71) Applicant: Alan Marnett, Somerville, MA (US)

(72) Inventor: Alan Marnett, Somerville, MA (US)

(73) Assignee: BenchFly Inc., Somerville, MA (US)

(21) Appl. No.: 13/684,200

(22) Filed: Nov. 22, 2012

Related U.S. Application Data
(60) Provisional application No. 61/563,525, filed on Nov. 23, 2011.

(51) Int. Cl. G06F 3/048

(52) U.S. Cl. CPC G06F 3/048
USPC 715/723

(57) ABSTRACT

The disclosure herein provides methods of editing personal videographic media, and related methods of converting personal videographic media to commercial grade video or offering editing services, as well as the products produced by these methods.

### RELATED APPLICATIONS

This application is a U.S. Utility application that claims the benefit of priority from U.S. Provisional Patent Application No. 61/563,525, filed on Nov. 23, 2011, the entirety of which is hereby incorporated herein by reference.

### BACKGROUND OF THE INVENTION

Since the advent of video recording equipment in the 1930s, access to the complex and expensive equipment required to carry out video production was largely restricted to industry professionals. As a result, recording, editing, and distributing professional video has traditionally been a time-consuming and costly process, often taking weeks to months to go from idea to finished video.

Although video recording equipment has evolved to the point where smart phones and tablets record video in high-definition, far less progress has been made in expanding access to professional-quality editing. Video editing is an art that can transform a non-professional video into something commercially marketable. However, such transformation requires a mastery of complex, advanced professional editing features included in advanced software. Furthermore, to create truly professional videos a unique editing solution for each video must be developed; a one-size-fits-all solution to video editing will not apply.

While internet-based editing software has recently emerged (e.g., JayCut, Movie Masher) and has made several editing features accessible to the public-at-large, the software is severely limited in it's functionality relative to professional editing software (e.g., Final Cut Pro, Avid, Adobe Premier Pro, etc.). Even simple editing software still demands a significant time commitment from the user to learn the functions and perform edits to each video.

Despite widespread advances in video production in recent decades, access to professional editing tools significantly limits access by the public-at-large to professional video production. Thus, schools, companies or individuals looking to produce professional-quality videos remain relegated to the expensive and time-consuming process of hiring and working with a professional video production crew.

As such, there's a need for a universally-accessible platform that enables users to create professional videos without the professional crew.

### SUMMARY OF THE INVENTION

The present invention provides a novel cross platform technology affording access to commercial grade video through an editing process that is as hands-off as possible for the user. In particular, the present invention provides methods of editing personal videographic media, and related methods of converting personal videographic media to commercial grade video or offering editing services, as well as the products produced by these methods.

Accordingly, in one aspect, the invention provides a method of editing personal videographic media. The method comprises the steps of:

(a) providing a user interface for receiving personal videographic media;

(b) receiving the personal videographic media (PVM) package on a first internet server uploaded by a user to said internet server; and

(c) performing one or more commercial grade edits on said PVM package, such that the PVM is edited.

In another aspect, the invention provides a method of editing personal videographic media comprising the steps of:

(a) providing a user interface for receiving personal videographic media;

(b) receiving a personal videographic media (PVM) package on an internet server uploaded by a user to said internet server;

(c) transcoding said PVM package; and

(d) performing one or more commercial grade edits on said transcoded PVM package, such that the PVM is edited.

In another aspect, the invention provides a method of converting personal videographic media (PVM) to commercial grade video (CGV). The method comprises the steps of:

(a) providing a website user interface for receiving personal videographic media;

(b) receiving a personal videographic media (PVM) package on an internet server uploaded by a user to said internet server through the website user interface;

(c) transcoding said PVM package;

(d) performing one or more commercial grade edits on said transcoded PVM package to produce a commercial grade video;

(e) transcoding said commercial grade video to allow said user to access the commercial grade video;

(f) uploading the commercial grade video to a second internet server; and

(g) providing access to said user to the commercial grade video through a second website user interface, such that the PVM is converted to CGV.

In yet another aspect, the invention provides a method of converting personal videographic media (PVM) to commercial grade video (CGV). The method comprises the steps of:

(a) providing a mobile application user interface for receiving personal videographic media;

(b) receiving a personal videographic media (PVM) package on an internet server uploaded by a user to said internet server through the mobile application user interface;

(c) transcoding said PVM package;

(d) performing one or more commercial grade edits on said transcoded PVM package to produce a commercial grade video;

(e) transcoding said commercial grade video to allow said user to access the commercial grade video;

(f) uploading the commercial grade video to a second internet server; and

(g) providing access to said user to the commercial grade video through a second mobile application user interface, such that the PVM is converted to CGV.

In another aspect the invention provides a product prepared by any of the methods described in the present invention.

In an additional aspect, the invention provides a method of offering editing services using a web interface. The method comprises the steps of:

(a) preparing a website user interface for receiving a personal videographic media (PVM) package on an internet server uploaded by a user to said internet server through said website user interface;

(b) providing access to said website user interface to a user for uploading said PVM package;

(c) receiving a personal videographic media (PVM) package on an internet server uploaded by said user to said internet server through said website user interface;

(d) transcoding said PVM package;

(e) performing one or more commercial grade edits on said transcoded PVM package to produce a commercial grade video;

(f) transcoding said commercial grade video to allow said user to access the commercial grade video;

(g) uploading the commercial grade video to a second internet server; and

(h) providing access to said user to the commercial grade video through a second website user interface, such that editing services are provided.

Another aspect of the invention provides a method of offering editing services using a mobile application user interface. The method comprises the steps of:

(a) preparing a mobile application user interface for receiving a personal videographic media (PVM) package on an internet server uploaded by a user to said internet server through said mobile application user interface;

(b) providing access to said mobile application user interface to a user for uploading said PVM package;

(c) receiving a personal videographic media (PVM) package on an internet server uploaded by said user to said internet server through said mobile application user interface;

(d) transcoding said PVM package;

(e) performing one or more commercial grade edits on said transcoded PVM package to produce a commercial grade video;

(f) transcoding said commercial grade video to allow said user to access the commercial grade video;

(g) uploading the commercial grade video to a second internet server; and

(h) providing access to said user to the commercial grade video through a second mobile application user interface, such that editing services are provided.

### BRIEF DESCRIPTION OF FIGURES

FIG. 1 depicts the flow of the personal videographic media package from source, e.g., a user, to edited commercial grade video.

### DETAILED DESCRIPTION OF THE INVENTION

In 2005, YouTube and other video hosting websites changed the process of video production by creating an internet-based video distribution and consumption platform accessible to anyone with an Internet connection. Not surprisingly, these platforms (Vimeo, Viddler, Brightcove, and others) have become saturated with low-quality videos due to user inexperience in video recording and editing. In contrast, the present invention provides those same users convenient access to commercial grade video production via the methods of the present invention. In particular, the disclosure provided herein describe methods of editing personal videographic media, and related methods of converting personal videographic media to commercial grade video or offering editing services, as well as the products produced by these methods.

Furthermore, the present invention, including novel methods and products, and uses thereof will be described with reference to the following definitions that, for convenience, are set forth below. Unless otherwise specified, the below terms used herein are defined as follows:

### I. Definitions

The language, “personal videographic media package,” or “PVMP” are used interchangeably herein to describe a package or group of files comprising personal videographic media, such as a data set containing video or images, along with instructions for editing or text for inclusion within a commercial grade video prepared according to the present invention.

The language, “personal videographic media,” or “PVM” are used interchangeably herein to describe any video file, image file, or combination thereof, and which may additionally contain textual information, which was created by a user as defined herein through the use of personal videographic equipment such as a camera (e.g., still or video), computer, smart phone, or converted from other formatting to an electronic file suitable for digital transfer. By their very nature, PVM are not suitable for commercial marketing.

The term “User,” or “user” as used herein, describes an entity, e.g., a human- or software-agent, in possession of PVM that is capable of utilizing a computer, mobile device or other networked system to interact with a user interface for receiving a PVMP. In certain embodiments, users may be required to authenticate themselves with a password or other credentials in order to gain access to the user interface.

The term “access” as used herein describes the ability to interact with a user interface or other components to view, alter, and/or download a certain file, files, video, or videos either freely or following password authentication.

The term “interface” for example, as used in the expression “website interface,” is used to describe the boundary or junction between a user and a program, application, site or system that affords the user a method of interacting or communicating with the program, application, site or system through which information may be added, removed or exchanged. Interfaces may include, for example, web, mobile application, or computer-based operating systems and control. User interfaces provide a means of input, allowing users to manipulate a system, and output, allowing the system to display the effects of the users' manipulations.

The language, “commercial grade video,” or “CGV” are used interchangeably herein to describe a video that is of a type and quality that suitable for commercial marketing purposes. A commercial grade video may be prepared by the methods of the present invention through the application of certain edits, either based on total number of edits (e.g., low quality edits) producing a video that is of the type and quality suitable for commercial marketing, or based on the application of edits from the advanced editing array of edits. CGV may be characterized as visually engaging, polished, or may involve advanced visual effects, and as such, have commercial value.

The language, “commercial grade edit,” or “CGE” are used interchangeably herein to describe an individual modification performed on personal videographic media that result in conversion of said PVM to a commercial grade video. An edit selection or selections may be classified as a commercial grade edit either based on total number of edits (e.g., relating to low quality edits) that in total produce a video that is of the type and quality suitable for commercial marketing (i.e., previously unattainable even by using the total available low quality edits at one time), or is an edit selected from the advanced editing array of edits. In certain embodiments, low quality edits may be classified as commercial grade edits when performed in groups that include at least 5 edit selections, e.g., at least 10 edit selections, e.g., at least 12 edit selections, e.g., at least 15 edit selections, e.g., at least 20 edit selections, e.g., at least 25 edit selections. Moreover, separately or in groupings of less total number, such edits would be classified as low quality edits, and not commercial grade edits.

The language “low quality edit” as used herein, describe edit features and edit levels of existing online editors that are not suitable for producing commercially marketable video, or a CGV of the present invention. Low quality edits include edits related to simple edits in brightness, hue, saturation, grey scale, titles, transitions, audio dubbing, basic special effects, basic rendering, addition of basic graphics, or stabilization.

The language, “advanced editing array” include those editing options that are currently unavailable by online editing features, i.e., low quality edits. As such, all edits in the advanced editing array are considered commercial grade, and any single edit from the advanced editing array may be used to produce a CGV. In certain embodiments, the commercial grade edit in the advanced editing array may be similar in nature to a low quality edit as described herein, but differs in strength and/or degree, and as such offers a greater degree of improved commercial video production. In certain embodiments, the advanced editing array includes an edit that falls within a filter selected from the group consisting of blur filters, border filters, channel filters, color correction filters, distortion filters, glow filters, image control filters, key filters, matte filters, perspective filters, sharpen filters, stylize filters, tiling filters, time filters, video filters, and audio filters.

### II. Methods of the Invention

The present invention provides methods wherein personal videographic media (PVM) is edited through the application of commercial grade editing. In certain embodiments, the PVM is converted to commercial grade video (CGV). In certain embodiments, the method of editing is part of a service offered to users.

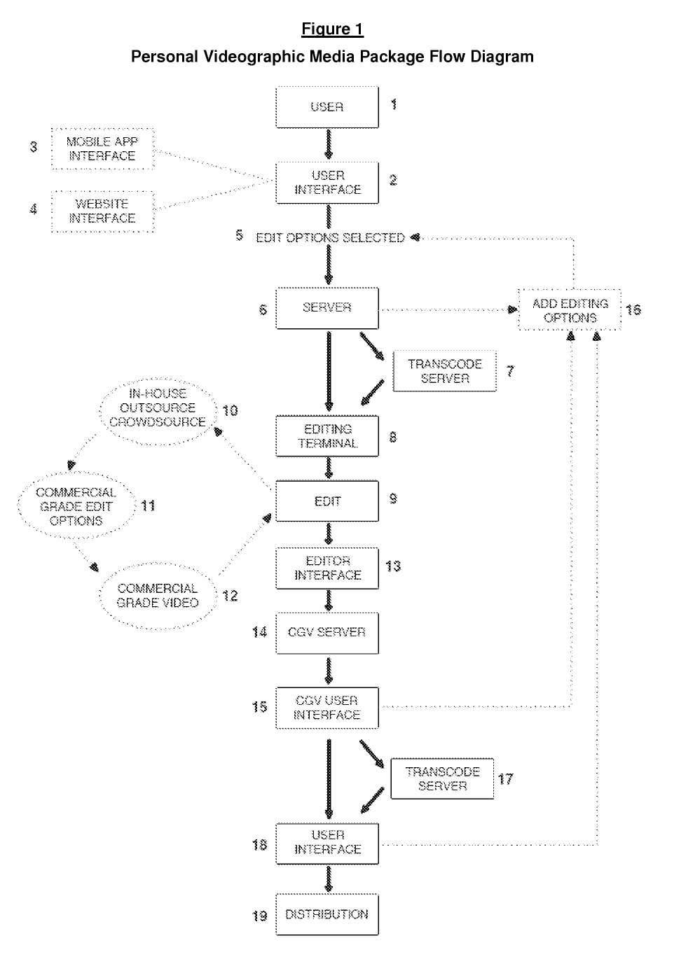

In one embodiment, the methods of the present invention, and the flow of the PVM from source, e.g., a user, to edited commercial grade video is depicted in FIG. 1.

Personal Videographic Media Packages (PVMPs) are uploaded by User 1 via the User Interface 2. In certain embodiments, the User Interface 2 may be Mobile Application Interface 3 or Website User Interface 4.

The PVMP may contain picture files, video, or any combination thereof. In certain embodiments, the PVM package may also contain text.

Without intending to be limiting, mobile applications affording Mobile Application Interface 3 may be coded in JavaScript, iOS, Action Script, HTML, CSS, C, C++, Visual Basic, XML, Lua, Objective-C, Object Pascal, JMango, C#, Python, Pascal, VB.NET, Basic4 ppc, HTML5, jQuery Mobile and/or PhoneGap. In addition, without intending to be limiting, websites affording Website User Interface 4 may be coded in .NET, ASP.NET, C#, Visual Basic .NET, ASP 3.0, Assembly, C, C++, Cobol, Cold Fusion, Delphi, HTML, J2EE, Java, JavaScript, Perl, PHP, Python, QBasic, Ruby on Rails, SQL, Visual Basic, and/or XML.

From User Interface 2, User 1 may select commercial grade Edit Options 5 to be executed on the specific PVMP being uploaded. PVMP files are uploaded to and stored on a Server 6, where User 1 will have opportunity to add commercial grade Editing Options 16. PVMP files may be transferred directly to the Editing Terminal 8, or alternatively, they may be converted to various file types by passing the PVMP files through/to the Transcode Server 7. In certain embodiments, Server 6 is same server as the Transcode Server 7. In certain embodiments, the PVMP files may be stored on Server 6. In certain embodiments, the PVMP files may be stored on Transcode Server 7, wherein such files would be accessed by the Editing Terminal 8 directly or indirectly through Server 6.

In certain embodiments, the PVM package is transcoded prior to performing the commercial grade edits. Transcoding, in particular embodiments, will be based on the player to be used to view the files, i.e., the present invention may be used with any video codec and corresponding player. Video codecs and players are well known in the art, and are not intended to limit the present invention. In a particular embodiment, the PVM package is transcoded to Flash video format.

The commercial grade editing options, such as Edit Options 5, and Editing Options 16 are commercial grade either based on the number of edit options available for one PVM package at one time, or based on its listing within the advanced editing array of edits. In one embodiment, the commercial grade edits include at least 5 edit selections (e.g., at least 10 edit selections, e.g., at least 12 edit selections, e.g., at least 15 edit selections) from the commercial grade edit list. In certain embodiments, the commercial grade edits include at least 1 edit selections from the edit selections in the advanced editing array. The advanced editing array includes an edit that falls within a filter selected from the group consisting of blur filters, border filters, channel filters, color correction filters, distortion filters, glow filters, image control filters, key filters, matte filters, perspective filters, sharpen filters, stylize filters, tiling filters, time filters, video filters, and audio filters. In certain embodiments, the commercial grade edit is performed on the server, i.e., Server 6. In certain other embodiments, the commercial grade edit is not performed on the server, i.e., Server 6.

In certain embodiments, the commercial grade edit in the advanced editing array is selected from the group consisting of Channel blur, Circle blur, Compound blur, Defocus, Directional blur, Gaussian blur, Movement blur, Prism, Radial blur, Soft focus, Wind blur, and Zoom blur.

In certain embodiments, the commercial grade edit in the advanced editing array is selected from the group consisting of Basic border and Bevel.

In certain embodiments, the commercial grade edit in the advanced editing array is selected from the group consisting of Arithmetic, Channel blur, Channel mixer, Channel offset, Channel swap, Color offset, Compound arithmetic, and Invert.

In certain embodiments, the commercial grade edit in the advanced editing array is selected from the group consisting of Color corrector, Color corrector 3-way, Desaturate highlights, Desaturate lows, RGB Balance, and RGB limit.

In certain embodiments, the commercial grade edit in the advanced editing array is selected from the group consisting of Black hole, Bulge, Bump Map, Cylinder, Disc Wrap, Displace, Droplet, Earthquake, Fisheye, Fun house, Glass distortion, Insect eye, Poke, Pond Ripple, Refraction, Ring Lens, Ripple, Scrape, Starburst, Stripes, Target, Twirl, Wave, and Whirlpool.

In certain embodiments, the commercial grade edit in the advanced editing array is selected from the group consisting of Bloom, Dazzle, Gloom, Glow, Light Rays, Outer Glow, and Overdrive.

In certain embodiments, the commercial grade edit in the advanced editing array is selected from the group consisting of Brightness and Contrast, Color balance, Color Reduce, Colorize, Desaturate, Equalize, Gamma Correction, Gradient colorize, HSV adjust, Levels, Negative, Proc Amp, Reduce banding, Saturate, Sepia, Threshold, Tint, YIQ Adjust, and YUV Adjust.

In certain embodiments, the commercial grade edit in the advanced editing array is selected from the group consisting of Blue and Green screen, Chroma Keyer, Color Key, Color Smoothing, Difference Matte, Luma Key, Primatte RT, Spill Supressor—Blue, and Spill Supressor—Green.

In certain embodiments, the commercial grade edit in the advanced editing array is selected from the group consisting of Eight-point garbage matte, Extract, Four-point garbage matte, Image mask, Mask feather, Mask shape, Matte choker, Matte magic, Soft edges, and Widescreen.

In certain embodiments, the commercial grade edit in the advanced editing array is selected from the group consisting of Basic 3D, Curl, Flop, Mirror, and Rotate.

In certain embodiments, the commercial grade edit in the advanced editing array is selected from the group consisting of Sharpen Filters, Sharpen, and Unsharp Mask.

In certain embodiments, the commercial grade edit in the advanced editing array is selected from the group consisting of Add noise, Anti-alias, Bad film, Bad tv, Circle screen, Circles, Color Emboss. Crystallize, Diffuse, Edge work, Edges, Emboss, Extrude, Find edges, Halftone, Hatched screen, Indent, Line art, MiniMax, Noise Dissolve, Posterize, Relief, Replicate, Slit Scan, Slit tunnel, Solarize, Texture screen, Vectorize color, and Vignette.

In certain embodiments, the commercial grade edit in the advanced editing array is selected from the group consisting of Kaleidoscope, Kaleidotile, Offset, Perspective tile, Random tile, Tile, and Triangle tile.

In certain embodiments, the commercial grade edit in the advanced editing array is selected from the group consisting of Echo, Scrub, Strobe, Trails, and WideTime.

In certain embodiments, the commercial grade edit in the advanced editing array is selected from the group consisting of Blink, De-interlace, Flicker filter, Shift fields, SmoothCam, Stop Motion blur, Strobe, Timecode generator, Timecode reader, and Viewfinder.

In certain embodiments, the commercial grade edit may be adding music, flash animation, cartoon animation, in-video quizzes, in-video games, in-video contact forms, or 3D rendering.

In certain embodiments, the commercial grade edit is selected from one or more of the following edits: Split Edits, Audio Editing, Trimming Clips, Adding Transitions, Refining Transitions, Sound signal-to-noise Ratio, Adjust Audio Headroom and Distortion, Audio Dynamic Range and Compression, Stereo Audio, Digital Audio, Making Basic Audio Adjustments with the Audio Mixer, Making Stereo Pan Adjustments with the Audio Mixer, Panning Audio, Adjusting Clip Audio Levels and Pan Using Keyframes, Recording a Voiceover, Audio Equalization Filters, Audio Gain filters, Audio Compressor/Limiter Filter, Audio Expander/Noise Gate Filter, Audio Noise Reduction Filter, Audio Echo and Reverberation Filters, Exporting Audio for Mixing in Other Applications, Exporting Audio Tracks to Individual Files, Exporting Audio Output Groups to AIFF Files, Exporting Multichannel Quicktime Files, Exporting OMF Audio Files, Exporting Audio Clip, Information to an EDL, Exporting Audio for DVD, Cutting Dialogue, Cutting Music, Creating Motion Effects in the Canvas, Zooming into the Canvas, and Animating Motion Effects Using Keyframes, Changing Clip Speed, Working with Freeze Frames and Still Images, Creating Titles, and Using Color Correction.

In certain embodiments, the methods used in commercial editing under the present invention may be selected from one or more of the following edits: Drag-to-timeline editing, Three-point editing, Cutting Clips and Adjusting Duration, Linking and Editing Video and Audio in Sync, Working with Multiclips, Slip, Slide, Ripple and Roll Edits, Sequence-to-sequence Editing, Matching Frames and Playhead Synchronization, Working with Timecode, Measuring Sound Intensity, Assigning Output Channels and External Audio Monitors, Evaluating Levels with Audio Meters, Controlling Audio Levels with Audio Mixer, About Mixer Automation and Keyframe Recording, Using a Control Surface with the Audio Mixer, Controlling the Audio Mixer with a Control Surface, Recording Audio Mixer Keyframes Using a Control Surface, Mixing Audio in the Timeline and Viewer, Copying, Pasting and Removing Audio Attributes, Applying Filters on an Audio Clip, Modifying and Removing Filters, Automating Audio Filter Parameters with Keyframes, Making Real-Time Audio Filter Adjustments, Saving a filter or Transition as a Favorite, Installing Third-party audio Unit Filters, Organizing Audio for Multitrack Export, Efficiently Using the Frequency Spectrum, Working with Soundtrack Pro and Logic Pro, Creating Sountrack Pro Multitrack Projects, Applying a Video Filter to a Clip, Viewing and Adjusting a Filter's Parameters, Displaying Filter Bars in a Timeline, Enabling and Rearranging Filters, Copying and Pasting a Clip's Filters, Removing Filters from Clips, Installing and Managing Video Effects, Installing Video Filters, Transferring Effects Between Systems, Changing Motion Parameters, Using Cartesian Geometry to Position Clips, Using Wireframe Handles to Transform, Scale, and Rotate, Adjusting Parameters for Keyframed Effects, Reusing Effect and Motion Parameters, Compositing and Layering, Using Travel Mattes to Hide or Reveal Parts of a Clip, Using Keying, Mattes, and Masks, Using Mattes to Add or Modify Alpha Channels, Using Masks to Replace or Modify Alpha Channels, Creating Generator Clips and Adding them to Sequences, Using SmoothCam ImageS Stabilization Filter, Working with Motion and Shake, Working with Master Templates, Measuring and Setting Video Levels Preventing Illegal Broadcasts, Displaying Excess Luma and Chroma Levels in the Viewer and Canvas, Using Scopes Versus Looking at an External Monitor, Real-time Video Processing, Real-time Audio Processing, Rendering Video and Audio Clips, Working with Mixed-Format Sequences, Mixing Frame Rates, Nesting Nonmatching Sequences, Combining Interlaced Footage with Different Field Dominances, Combining SD and HD Video, Downconverting HD Video, Upconverting SD Video, Working with Master and Affiliate Clips, Diagnostic Tools for Clips, Importing and Exporting Edit Decision Lists, Using Metadata, Remote Previewing Footage, Working with Film and Cinema Tools, Removing 3:2 Pull-Down or Conforming 25 fps PAL to 24 fps, Using Edge Code Overlays and Feet+Frame Rulers, Exporting Film, Change and Audio Lists, Exporting QuickTime Movies, Exporting Sequences for DVD, Batch Exporting Clips and Sequences, and Video Capture Settings and Presets.

PVMPs on the Editing Terminal 8 (e.g., comprising an editor interface equivalent if not the same as Editor Interface 13) are then edited 9 as described herein using commercial grade edits via several possible sourcing mechanisms, 10, including but not limited to, in-house editing, out-sourcing to other individuals or companies, and crowd-sourcing. In certain embodiments, the user selects the sourcing in the User Interface 2. The editor will then execute the Commercial Grade Edits (CGE) 11 on the selected files of the PVMP. The editing process produces a Commercial Grade Video 12, which may then be uploaded via the Editor Interface 13 to the CGV server 14, where it is stored. In certain embodiments, the CGV server is same as the Server 6 and/or Transcode Server 7. The CGV 12, may be accessed on CGV Server 14 through the CGV Server Interface 15 or may be accessed through the User Interface 18 directly from the CGV Server 14 or indirectly through Transcode Server 17. In certain embodiments, the CGV 12, may be stored on Transcode Server 17, e.g., being uploaded directly to Transcode Server 17 or passing through CGV Server 14 (e.g., wherein CGV Server 14 may be the same as Server 6. In certain embodiments, the Editor Interface 13 is the same as User Interface 2.

In certain embodiments, the Commercial Grade Video 12 is transcoded prior to uploading to a second server, CGV Server 14 or Transcode Server 17. In certain embodiments, the Commercial Grade Video 12 is transcoded subsequent to uploading the commercial grade video to a second internet server, CGV Server 14, but prior to providing access to a user to the Commercial Grade Video 12. In a particular embodiment, the CGV is transcoded to Flash video format.

A user, e.g., User 1, may select a specific CGV 12, or multiple CGVs through a third interface, the User Interface 18, and select Additional Editing Options 18 to be performed on the CGV 12. CGVs identified for further edits may be transferred to the Server 6, where the CGV will be processed again through the processing described above, and edited as would a newly uploaded PVMP. In this way, the CGV 12 may be further edited through Editing Options 16 from either the CGV User Interface 15 or the User Interface 18 (e.g., by User 1). In certain embodiments, CGV User Interface 15 is used for quality control review, and/or which interface may be removed from the flow diagram. CGVs that are not selected for additional editing, are stored on CGV Server 14 or Transcode Server 17.

In certain embodiments, the CGV User Interface is the same as User Interface 2 and/or Editor Interface 14.

In certain embodiments, the CGV User Interface 15 is the same as the User Interface 18. In certain embodiments, the CGV User Interface 15 is the same as the User Interface 2. In certain embodiments, the CGV User Interface 15 and the User Interface 18 are the same as the User Interface 2.

CGVs stored on the CGV Server 14 or Transcode Server 17 may be accessed directly by users, e.g., User 1, via the User Interface 18. Alternatively, in certain embodiments, users may obtain the CGV by alternate means of “distribution,” e.g., means by which a user could receive a digital commercial grade video file. Such CGV may be used, without limitation, on the Internet, CD, DVD or television.

In further embodiments, the CGV or PVMP may be associated by appropriate means, with a QR code, embed code, and/or a transcript that may be stored on any one of the servers described above, and accessed by any one of the interfaces described above.

Accordingly, in one embodiment, users interact with a website to upload PVMPs to the server. Users may include specific editing requests via the website interface prior to uploading the PVM to the server, or by using the website interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the website interface where users will view the CGV. Users may select additional editing options through the website interface and the CGV will be returned to the beginning of the workflow where it will be subjected to further commercial grade edits. Once the user approves of the final CGV, they may distribute the video using the website interface.

In another embodiment, users interact with a website to upload PVMPs to the server. Users may include specific editing requests via the website interface prior to uploading the PVM to the server, or by using the website interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the website interface where users will view the CGV. Users may select additional editing options through the website interface and the CGV will be returned to the beginning of the workflow where it will be subjected to further commercial grade edits. Once the user approves of the final CGV, they may distribute the video using the mobile application interface.

In another embodiment, users interact with a mobile application interface to upload PVMPs to the server. Users may include specific editing requests via the website interface prior to uploading the PVM to the server, or by using the website interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the website interface where users will view the CGV. Users may select additional editing options through the website interface and the CGV will be returned to the beginning of the workflow where it will be subjected to further commercial grade edits. Once the user approves of the final CGV, they may distribute the video using the website interface.

In another embodiment, users interact with a mobile application interface to upload PVMPs to the server. Users may include specific editing requests via the mobile application interface prior to uploading the PVM to the server, or by using the mobile application interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the website interface where users will view the CGV. Users may select additional editing options through the website interface and the CGV will be returned to the beginning of the workflow where it will be subjected to further commercial grade edits. Once the user approves of the final CGV, they may distribute the video using the website interface.

In another embodiment, users interact with a mobile application interface to upload PVMPs to the server. Users may include specific editing requests via the mobile application interface prior to uploading the PVM to the server, or by using the mobile application interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the mobile application interface where users will view the CGV. Users may select additional editing options through the mobile application interface and the CGV will be returned to the beginning of the workflow where it will be subjected to further commercial grade edits. Once the user approves of the final CGV, they may distribute the video using the website interface.

In another embodiment, users interact with a mobile application interface to upload PVMPs to the server. Users may include specific editing requests via the mobile application interface prior to uploading the PVM to the server, or by using the mobile application interface after PVMP uploading has been completed. PVM files may then optionally be transferred to a separate transcode server where files will be converted and stored. Once video editing options have been selected by the user, PVM files will be downloaded to a separate editing terminal where the files will be edited according to the user's instructions. After completing the commercial grade edits, editors will upload the commercial grade videos to the CGV server using the web-based editor interface. CGVs will be approved for quality and, if necessary, additional edits will be selected and the CGV will be returned to the beginning of the workflow where they will be subjected to further commercial grade edits. To ensure compatibility of the CGV and its final playing format, the CGV may be uploaded to the transcode server for final conversion and storage. Alternatively, the CGV may be transferred directly to the mobile application interface where users will view the CGV. Users may select additional editing options through the mobile application interface and the CGV will be returned to the beginning of the workflow where it will be subjected to further commercial grade edits. Once the user approves of the final CGV, they may distribute the video using the mobile application interface.

### III. Additional Embodiments of the Present Invention

In one embodiment, the invention provides a method of editing personal videographic media comprising the steps of: providing a user interface for receiving personal videographic media; receiving the personal videographic media (PVM) package on a first internet server uploaded by a user to said internet server; and performing one or more commercial grade edits on said PVM package. In certain embodiments, the method comprises the additional steps of: producing a commercial grade video by performing said commercial grade edits on said PVM package; uploading the commercial grade video to a second internet server; and providing access to said user to the commercial grade video. In certain embodiments, the PVM package is transcoded prior to performing the commercial grade edits. In certain embodiments, the commercial grade video is transcoded prior to uploading to a second server. In certain embodiments, the commercial grade video is transcoded subsequent to uploading the commercial grade video to a second internet server, but prior to providing access to said user to the commercial grade video.

In another embodiment, the present invention provides a method of editing personal videographic media comprising the steps of: providing a user interface for receiving personal videographic media; receiving a personal videographic media (PVM) package on an internet server uploaded by a user to said internet server; transcoding said PVM package; and performing one or more commercial grade edits on said transcoded PVM package. In certain embodiments, the method comprises the additional steps of: producing a commercial grade video by performing said commercial grade edits on said PVM package; transcoding said commercial grade video to allow said user to access the commercial grade video; uploading the commercial grade video to a second internet server; and providing access to said user to the commercial grade video.

In certain embodiments of the present invention the second internet server is the same as said first internet server.

In certain embodiments of the present invention the PVM package is selected from the group consisting of picture files, video, and a combination thereof. In particular embodiments, the PVM package also contains text.

In certain embodiments of the present invention the user interface is a first website user interface.

In certain embodiments of the present invention the user interface is a first mobile application interface.

In certain embodiments of the present invention the method includes the additional step of receiving instructions for editing prior to receiving the PVM package. In particular embodiments, the instructions for editing are received through a second user interface, e.g., a website user interface or a mobile application interface.

In certain embodiments of the present invention the method includes the additional step of receiving instructions for editing subsequent to receiving the PVM package but prior to performing the commercial grade edits. In particular embodiments, the instructions for editing are received through a second user interface, e.g., a website user interface or a mobile application interface.

In certain embodiments of the present invention the commercial grade edits include at least 5 edit selections (e.g., at least 10 edit selections) from the commercial grade edit list.

In certain embodiments of the present invention the commercial grade edits include at least 1 edit selections from the edit selections in the advanced editing array.

In certain embodiments of the present invention the commercial grade edits is an edit that falls within a filter selected from the group consisting of blur filters, border filters, channel filters, color correction filters, distortion filters, glow filters, image control filters, key filters, matte filters, perspective filters, sharpen filters, stylize filters, tiling filters, time filters, video filters, and audio filters.

In certain embodiments of the present invention the commercial grade edit is selected from the group consisting of Channel blur, Circle blur, Compound blur, Defocus, Directional blur, Gaussian blur, Movement blur, Prism, Radial blur, Soft focus, Wind blur, and Zoom blur.

In certain embodiments of the present invention the commercial grade edit is selected from the group consisting of Basic border and Bevel.

In certain embodiments of the present invention the commercial grade edit is selected from the group consisting of Arithmetic, Channel blur, Channel mixer, Channel offset, Channel swap, Color offset, Compound arithmetic, and Invert.

In certain embodiments of the present invention the commercial grade edit is selected from the group consisting of Color corrector, Color corrector 3-way, Desaturate highlights, Desaturate lows, RGB Balance, and RGB limit.

In certain embodiments of the present invention the commercial grade edit is selected from the group consisting of Black hole, Bulge, Bump Map, Cylinder, Disc Wrap, Displace, Droplet, Earthquake, Fisheye, Fun house, Glass distortion, Insect eye, Poke, Pond Ripple, Refraction, Ring Lens, Ripple, Scrape, Starburst, Stripes, Target, Twirl, Wave, and Whirlpool.

In certain embodiments of the present invention the commercial grade edit is selected from the group consisting of Bloom, Dazzle, Gloom, Glow, Light Rays, Outer Glow, and Overdrive.

In certain embodiments of the present invention the commercial grade edit is selected from the group consisting of Brightness and Contrast, Color balance, Color Reduce, Colorize, Desaturate, Equalize, Gamma Correction, Gradient colorize, HSV adjust, Levels, Negative, Proc Amp, Reduce banding, Saturate, Sepia, Threshold, Tint, YIQ Adjust, and YUV Adjust.

In certain embodiments of the present invention the commercial grade edit is selected from the group consisting of Blue and Green screen, Chroma Keyer, Color Key, Color Smoothing, Difference Matte, Luma Key, Primatte RT, Spill Supressor—Blue, and Spill Supressor—Green.

In certain embodiments of the present invention the commercial grade edit is selected from the group consisting of Eight-point garbage matte, Extract, Four-point garbage matte, Image mask, Mask feather, Mask shape, Matte choker, Matte magic, Soft edges, and Widescreen.

In certain embodiments of the present invention the commercial grade edit is selected from the group consisting of Basic 3D, Curl, Flop, Mirror, and Rotate.

In certain embodiments of the present invention the commercial grade edit is selected from the group consisting of Sharpen Filters, Sharpen, and Unsharp Mask.

In certain embodiments of the present invention the commercial grade edit is selected from the group consisting of Add noise, Anti-alias, Bad film, Bad tv, Circle screen, Circles, Color Emboss. Crystallize, Diffuse, Edge work, Edges, Emboss, Extrude, Find edges, Halftone, Hatched screen, Indent, Line art, MiniMax, Noise Dissolve, Posterize, Relief, Replicate, Slit Scan, Slit tunnel, Solarize, Texture screen, Vectorize color, and Vignette.

In certain embodiments of the present invention the commercial grade edit is selected from the group consisting of Kaleidoscope, Kaleidotile, Offset, Perspective tile, Random tile, Tile, and Triangle tile.

In certain embodiments of the present invention the commercial grade edit is selected from the group consisting of Echo, Scrub, Strobe, Trails, and WideTime.

In certain embodiments of the present invention the commercial grade edit is selected from the group consisting of Blink, De-interlace, Flicker filter, Image stabilization, Shift fields, SmoothCam, Stop Motion blur, Strobe, Timecode generator, Timecode reader, and Viewfinder.

In certain embodiments of the present invention the commercial grade edit is performed on the server.

In certain embodiments of the present invention the commercial grade edit is not performed on the server.

In certain embodiments of the present invention the PVM package or the commercial grade video is transcoded to Flash video format.

In certain embodiments of the present invention access is provided to said user to the commercial grade video through a third user interface.

In certain embodiments of the present invention access is provided to said user to the commercial grade video through distribution.

In certain embodiments of the present invention the method comprises the additional step of creating QR code for the PVM package on the first internet server. In certain embodiments, the method comprises the additional step of providing access to said user to the QR code.

In certain embodiments of the present invention the method comprises the additional step of creating QR code for the commercial grade video on the second internet server. In certain embodiments, the method comprises the additional step of providing access to said user to the QR code.

In certain embodiments of the present invention the method comprises the additional step of creating an embed code for the commercial grade video on the second internet server. In certain embodiments, the method comprises the additional step of providing access to said user to the embed code.

In certain embodiments of the present invention the method comprises the additional step of creating a transcript for the commercial grade video on the second internet server. In certain embodiments, the method comprises the additional step of providing access to said user to the transcript.

In another embodiment, the present invention provides a method of converting personal videographic media (PVM) to commercial grade video (CGV) comprising the steps of: providing a user interface (e.g. a website user interface or a mobile application user interface) for receiving personal videographic media; receiving a personal videographic media (PVM) package on an internet server uploaded by a user to said internet server through the user interface; transcoding said PVM package; and performing one or more commercial grade edits on said transcoded PVM package to produce a commercial grade video. In certain embodiments, the method further comprises the steps of transcoding said commercial grade video to allow the user to access the commercial grade video; uploading the commercial grade video to a second internet server; and providing access to the user to the commercial grade video through a second website user interface.

Another embodiment of the present invention provides a product prepared by any method described herein.

In an additional embodiment, the present invention provides a method of offering editing services using an internet interface, e.g., a web interface, comprising the steps of: preparing a user interface (e.g. a website user interface or a mobile application user interface) for receiving a personal videographic media (PVM) package on an internet server uploaded by a user to said internet server through said website user interface; providing access to the user interface to a user for uploading said PVM package; receiving a personal videographic media (PVM) package on an internet server uploaded by said user to said internet server through said website user interface; performing one or more commercial grade edits on said PVM package to produce a commercial grade video; uploading the commercial grade video to a second internet server; and providing access to said user to the commercial grade video through a second website user interface. In certain embodiments the method comprises transcoding said PVM package, transcoding said commercial grade video to allow said user to access the commercial grade video, or both. In certain embodiments, the commercial grade edit is performed by sourcing selected from the group consisting of in-house sourcing, out-sourcing, crowd-sourcing, and any combination thereof. In a particular embodiment, the user selects the sourcing through the user interface.

Moreover, the present invention includes any application of said methods described herein, including any software based on said methods. Such software shall comprise a machine-readable medium having instructions stored thereon for execution by a processor to perform any method of the present invention.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A method of editing personal videographic media comprising the steps of:
(a) providing a user interface for receiving personal videographic media;
(b) receiving the personal videographic media (PVM) package on a first internet server uploaded by a user to said internet server; and
(c) performing one or more commercial grade edits on said PVM package, such that the PVM is edited.

2. The method of claim 1, comprising the additional steps of:
(a) producing a commercial grade video by performing said commercial grade edits on said PVM package;
(b) uploading the commercial grade video to a second internet server; and
(c) providing access to said user to the commercial grade video.

3. The method of claim 1, wherein said PVM package is transcoded prior to performing the commercial grade edits.

4. The method of claim 2, wherein said commercial grade video is transcoded prior to uploading to a second server.

5. The method of claim 2, wherein said commercial grade video is transcoded subsequent to uploading the commercial grade video to a second internet server, but prior to providing access to said user to the commercial grade video.

6. A method of editing personal videographic media comprising the steps of:
(a) providing a user interface for receiving personal videographic media;
(b) receiving a personal videographic media (PVM) package on an internet server uploaded by a user to said internet server;
(c) transcoding said PVM package; and
(d) performing one or more commercial grade edits on said transcoded PVM package, such that the PVM is edited.

7. The method of claim 6, comprising the additional steps of:
(a) producing a commercial grade video by performing said commercial grade edits on said PVM package;
(b) transcoding said commercial grade video to allow said user to access the commercial grade video;
(c) uploading the commercial grade video to a second internet server; and
(d) providing access to said user to the commercial grade video.

8. The method of claim 2, wherein the second internet server is the same as said first internet server.

9. The method of claim 1, wherein the PVM package is selected from the group consisting of picture files, video, and a combination thereof.

10. The method of claim 9, wherein the PVM package also contains text.

11. The method of claim 1, wherein the user interface is a first website user interface.

12. The method of claim 1, wherein the user interface is a first mobile application interface.

13. The method of claim 1, wherein the method includes the additional step of receiving instructions for editing prior to receiving the PVM package.

14. The method of claim 1, wherein the method includes the additional step of receiving instructions for editing subsequent to receiving the PVM package but prior to performing the commercial grade edits

15. The method of claim 13, wherein the instructions for editing are received through a second user interface.

16. The method of claim 15, wherein the second user interface is a website user interface.

17. The method of claim 15, wherein the second user interface is a mobile application interface.

18. The method of claim 1, wherein the commercial grade edits include at least 5 edit selections from the commercial grade edit list.

19. The method of claim 1, wherein the commercial grade edits include at least 1 edit selections from the edit selections in the advanced editing array.

20. A method of converting personal videographic media (PVM) to commercial grade video (CGV) comprising the steps of:
(a) providing a website user interface for receiving personal videographic media;
(b) receiving a personal videographic media (PVM) package on an internet server uploaded by a user to said internet server through the website user interface;
(c) transcoding said PVM package;
(d) performing one or more commercial grade edits on said transcoded PVM package to produce a commercial grade video;
(e) transcoding said commercial grade video to allow said user to access the commercial grade video;
(d) uploading the commercial grade video to a second internet server; and
(e) providing access to said user to the commercial grade video through a second website user interface, such that the PVM is edited.

21. A method of converting personal videographic media (PVM) to commercial grade video (CGV) comprising the steps of:
(a) providing a mobile application user interface for receiving personal videographic media;
(b) receiving a personal videographic media (PVM) package on an internet server uploaded by a user to said internet server through the mobile application user interface;
(c) transcoding said PVM package;
(d) performing one or more commercial grade edits on said transcoded PVM package to produce a commercial grade video;
(e) transcoding said commercial grade video to allow said user to access the commercial grade video;
(f) uploading the commercial grade video to a second internet server; and
(g) providing access to said user to the commercial grade video through a second mobile application user interface, such that the PVM is converted to CGV.
